(19) United States
(12) Patent Application Publication
(10) Pub. No.: US 2014/0067542 A1
(43) Pub. Date: Mar. 6, 2014

(54) Image-Based Advertisement and Content Analysis and Display Systems

(71) Applicant: James R. Everingham, Santa Cruz, CA (US)

(72) Inventor: James R. Everingham, Santa Cruz, CA (US)

(73) Assignee: LUMINATE, INC., Mountain View, CA (US)

(21) Appl. No.: 13/599,991

(22) Filed: Aug. 30, 2012

(51) Int. Cl. G06Q 30/02

(52) U.S. Cl. 705/14.64

(57) ABSTRACT

Disclosed are computer-implement systems and methods for identifying and analyzing content (e.g., images, videos, text, etc.) published on digital content platforms (e.g., webpages, mobile applications, etc.). Such analysis is used to identify contextually relevant content (e.g., advertisements, images, videos, etc.) for publication proximate to the originally published content. Embodiments of the present invention are also directed to user-interface systems and methods for displaying such contextually relevant content. Example embodiments generally include: (a) publishing an image on the mobile device software application; (b) providing one or more actionable user to activate the image and provide an indication of interest; (c) identifying when an end-user has activated the image; and (d) upon an end-user's activation of one or more of the actionable user interfaces, displaying contextually relevant content to the end-user based on the activated user interface.

### SUMMARY

Disclosed herein are computer-implement systems and methods for identifying and analyzing content (e.g., images, videos, text, etc.) published on digital content platforms (e.g., webpages, mobile applications, etc.). Such analysis is then used to identify contextually relevant content (e.g., advertisements, images, videos, etc.) for publication proximate to the originally published content. Embodiments of the present invention are also directed to user-interface systems and methods for displaying such contextually relevant content. In one embodiment, for example, the systems and methods presented are particularly useful for providing advertisements on mobile software applications and/or web browsers on mobile devices—where screen sizes and usable “space” for publishing content are relatively limited. Embodiments presented are also directed to the “back-end” mechanisms that make the disclosed systems and methods commercially viable.

In example embodiments, there are provided systems and methods for displaying advertisements associated with images published in a mobile device software application. The systems and methods generally include: (a) publishing an image on the mobile device software application; (b) providing one or more actionable user to activate the image and provide an indication of interest; (c) identifying when an end-user has activated the image; and (d) upon an end-user's activation of one or more of the actionable user interfaces, displaying contextually relevant content to the end-user based on the activated user interface. In one embodiment, for example, the presented systems and methods include: (a) publishing an image on a mobile device software application; (b) identifying when an end-user has activated the image; (c) providing one or more hotspots on the image, wherein each hotspot is positionally matched to content within the image, and wherein each hotspot is linked to an advertisement selected based in part on the positionally matched content within the image; and (d) upon an end-user's swiping of an end-user selected hotspot, displaying the advertisement linked to the end-user selected hotspot.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating an embodiment of the present invention.

FIG. 2 is a high-level diagram illustrating another embodiment of the present invention.

FIGS. 3A-3I are screenshots showing various implementations of the disclosed systems and methods.

### DEFINITIONS

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

“Advertisement” or “ad”: One or more images, with or without associated text, to promote or display a product or service. Terms “advertisement” and “ad,” in the singular or plural, are used interchangeably.

“Ad Creative” or “Creative”: Computer file with advertisement, image, or any other content or material related to a product or service. As used herein, the phrase “providing an advertisement” may include “providing an ad creative,” where logically appropriate. Further, as used herein, the phrase “providing a contextually relevant advertisement” may include “providing an ad creative,” where logically appropriate.

Ad server: One or more computers, or equivalent systems, which maintains a catalog of creatives, delivers creative(s), and/or tracks advertisement(s), campaigns, and/or campaign metrics independent of the platform where the advertisement is being displayed.

Campaign: The process or program of planning, creating, buying, and/or tracking an advertising project.

“Contextual information” or “contextual tag”: Data related to the contents and/or context of digital content (e.g., an image, or content within the image); for example, but not limited to, a description, identification, index, or name of an image, or object, or scene, or person, or abstraction within the digital content (e.g., image).

Contextually relevant advertisement: A targeted advertisement that is considered relevant to the contents and/or context of digital content on a digital content platform.

Crowdsource network: One or more individuals, whether human or computer, used for a crowdsourcing application.

Crowdsourcing: The process of delegating a task to one or more individuals, with or without compensation.

Digital content: Broadly interpreted to include, without exclusion, any content available on a digital content platform, such as images, videos, text, audio, and any combinations and equivalents thereof.

Digital content platform: Broadly interpreted to include, without exclusion, any webpage, website, browser-based web application, software application, mobile device application (e.g., phone or tablet application), TV widget, and equivalents thereof.

Image: A visual representation of an object, or scene, or person, or abstraction, in the form of a machine-readable and/or machine-storable work product (e.g., one or more computer files storing a digital image, a browser-readable or displayable image file, etc.). As used herein, the term “image” is merely one example of “digital content.” Further, as used herein, the term “image” may refer to the actual visual representation, the machine-readable and/or machine-storable work product, location identifier(s) of the machine-readable and/or machine-storable work product (e.g., a uniform resource locator (URL)), or any equivalent means to direct a computer-implemented system and/or user to the visual representation. As such, process steps performed on “an image” may call for different interpretations where logically appropriate. For example, the process step of “analyzing the context of an image,” would logically include “analyzing the context of a visual representation.” However, the process step of “storing an image on a server,” would logically include “storing a machine-readable and/or machine-storable work product, or location identifier(s) of the machine-readable and/or machine-storable work product (e.g., uniform resource locator (URL)) on a server.” Further, process steps performed on an image may include process steps performed on a copy, thumbnail, or data file of the image.

Merchant: Seller or provider of a product or service; agent representing a seller or provider; or any third-party charged with preparing and/or providing digital content associated with a product or service. For example, the term merchant should be construed broadly enough to include advertisers, an ad agency, or other intermediaries, charged with developing a digital content to advertise a product or service.

Proximate: Is intended to broadly mean “relatively adjacent, close, or near,” as would be understood by one of skill in the art. The term “proximate” should not be narrowly construed to require an absolute position or abutment. For example, “content displayed proximate to an image,” means “content displayed relatively near an image, but not necessarily abutting or within the image.” (To clarify: “content displayed proximate to an image,” also includes “content displayed abutting or within the image.”) In another example, “content displayed proximate to an image,” means “content displayed on the same screen page or webpage as the image.”

Publisher: Party that owns, provides, and/or controls digital content or a digital content platform; or third-party who provides, maintains, and/or controlls, digital content and/or ad space on a digital content platform.

### INCORPORATION BY REFERENCE OF RELATED APPLICATIONS

Except for any term definitions that conflict with the term definitions provided herein, the following related, co-owned, and co-pending applications are incorporated by reference in their entirety: U.S. patent application Ser. Nos. 12/902,066; 13/045,426; 13/151,110; 13/219,460; 13/252,053; 13/299,280; 13/308,401; 13/299,280; 13/398,700; 13/427,341; 13/473,027; 13/486,628; 13/545,443; and 13/564,609; and U.S. Patent Application Publications Nos. 2012/0177297; 2012/0179544; and 2012/0179545; as well as U.S. Pat. Nos. 8,166,383; and 8,234,168.

### DETAILED DESCRIPTION

A growing trend in modern computing devices is to limit screen sizes in order to make devices more compact and portable. For example, where the desktop computer was once commonplace, more recently end-users are accessing software programs and the Internet on small mobile devices, such as tablets and mobile phones. Limitations in the size of display screens, web browsers, application interfaces, and pixel count create limitations on the amount of content a publisher can effectively provide on a digital content platform. The problem is compounded when publishers try to cram images, videos, text, and advertisements into a relatively small amount of space, without ruining the aesthetic look of the publication. As such, a publisher desires to maximize their use of “space” when publishing content on a digital content platform.

Images are typically the most information-rich content a publisher can provide. Images provide condensed, high-density information. Publishers, however, seldom have the mechanisms to make an image interactive, so as to provide additional/supplemental content if/when a reader is interested in the image. For example, a publisher may post an image of himself preparing for a motorcycle ride on a mobile device software application (or “app”) such as FACEBOOK™ CAMERA or INSTAGRAM™. A viewer (i.e., end-user) of the image may wonder: Where can I buy that motorcycle jacket? What do similar motorcycles look like? Where can I get more information about helmets? However, if the publisher wishes to add advertisements/content for jackets, similar motorcycles, and/or helmets, the original image would quickly become overcrowded with ads, information, functionality, etc. Additionally, the publisher may wish to concentrate his time on creating and sharing additional images, instead of trying to identify and create content for all possible end-user interactions with originally published images.

The present invention generally relates to computer-implemented systems and methods for providing and displaying contextually relevant content for an image published on a digital content platform. The present invention thereby provides means for publishers to effectively maximize their use of space on a digital content platform, such as a mobile device software application platform. In conjunction with the systems and methods presented, a publisher can provide an image on a digital content platform, and a service provider can provide contextually relevant content, relative to the image, if/when a reader (i.e., an end-user) interacts with or shows interest in the image (or specific content within the image). As would be understood by one of skill in the art, the role of the service provider can be performed by an entity independent of the publisher, an agent of the publisher, or a separate function of the publisher.

The systems and methods generally include: (a) publishing an image on the mobile device software application; (b) providing one or more actionable user to activate the image and provide an indication of interest; (c) identifying when an end-user has activated the image; and (d) upon an end-user's activation of one or more of the actionable user interfaces, displaying contextually relevant content to the end-user based on the activated user interface. In one embodiment, for example, the presented systems and methods include: (a) publishing an image on the mobile device software application; (b) identifying when an end-user has activated the image; (c) providing one or more hotspots on the image, wherein each hotspot is positionally matched to content within the image, and wherein each hotspot is linked to an advertisement selected based in part on the positionally matched content within the image; and (d) upon an end-user's swiping of an end-user selected hotspot, displaying the advertisement linked to the end-user selected hotspot.

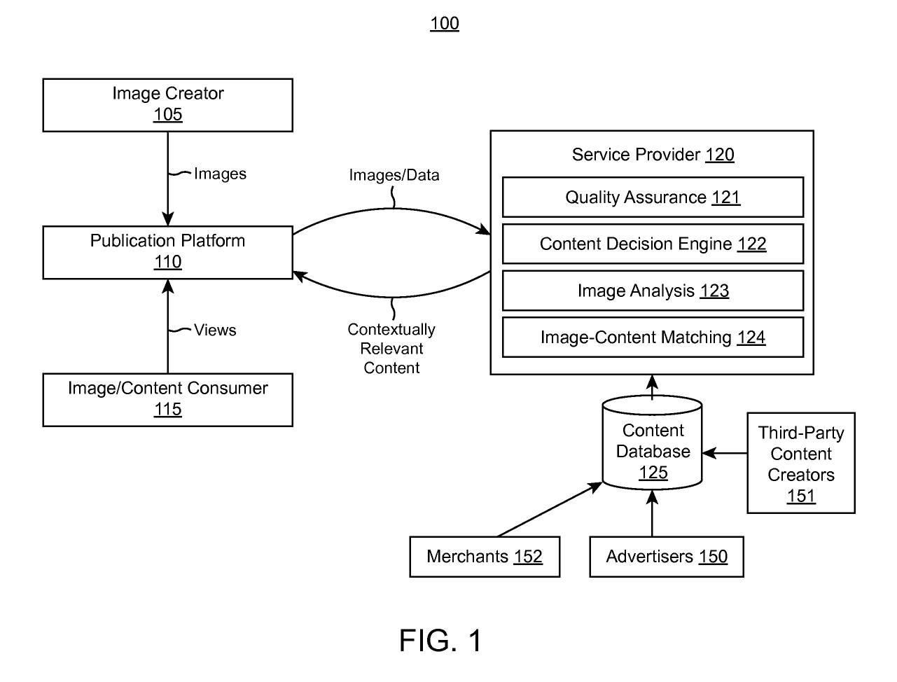

FIG. 1 is a high-level diagram illustrating an embodiment of the present invention. FIG. 1 shows a system and method 100 of identifying, providing, and displaying digital content on a digital content platform. As shown in FIG. 1, an image creator 105 (e.g., a publisher of user-generated content) provides one or more images to a publication platform 110. The publication platform 110 may be a web page, website, browser-based web application, software application, mobile device application (e.g., phone or tablet application), TV widget, or equivalents thereof. The images are displayed on the publication platform 110 and available for viewing by one or more image/content consumers 115 (i.e., end-users). An end-user may employ an end-user device (e.g., a computer, tablet, mobile phone, television, etc.) to access the publication platform 110.

The images (or image identifiers, or image data thereof) may then be provided to a service provider 120 for analysis. In practice, the service provider 120 may employ one or more analysis mechanisms to ultimately return contextually relevant content to the publication platform 110. The contextually relevant content can then be displayed proximate to the images on the publication platform 110. Analysis mechanisms employed by the service provider 120 may include one or more of: a quality assurance engine 121, a content decision engine 122, an image analysis engine 123, an image-content matching engine 124, and/or any combinations or equivalents thereof. Embodiments of such analysis mechanisms are described in more detail below, as well as in the above cited patents and applications, which have been incorporated by reference herein.

In one embodiment, the service provider 120 may provide a software widget (e.g., web widget, executable computer code, computer-readable instructions, reference script, HTML script, etc.) for inclusion in the publication platform 110. As such, the software widget may analyze the publication platform 110 in order to identify any and all of the images published on the platform. For example, the software widget can provide the function of “scraping” the publication platform 110 for images (e.g., by walking the DOM nodes on an HTML script of a web page). In one embodiment, the software widget can be configured to identify published images that meet predefined characteristics, attributes, and/or parameters. Additionally, the software widget can provide the function of scraping the platform to identify any and all “referrer data.” The software widget can also provide the function of identifying the image creator 105 for any particular image(s). The software widget then provides (or otherwise identifies) the images and/or image data (including, for example, publisher data) to the service provider 120 for further analysis.

The analysis of the images may occur within a dedicated content server maintained by the service provider 120. Analysis of the images generally results in the identification of contextually relevant content associated with content within the images. For example, if an image depicts a professional athlete, contextually relevant content may include information about the athlete's career, recent activities, associated product advertisements, etc. In another example, if an image depicts a vacation setting, the contextually relevant content may include where the setting is located, advertisements on how to get to the vacation site, and other relevant information. Contextually relevant content may also include one or more third-party, in-image applications, which function based in part on the content/context/analysis of the image, and relevant image data provided by the service provider. Such contextually relevant content may be stored in one or more content databases 125, and may be initially provided by one or more advertisers 150, third-party content creators 151, and/or merchants 152. Such contextually relevant content is then provided back to the publication platform 110, for publication proximate to the image, as further discussed below.

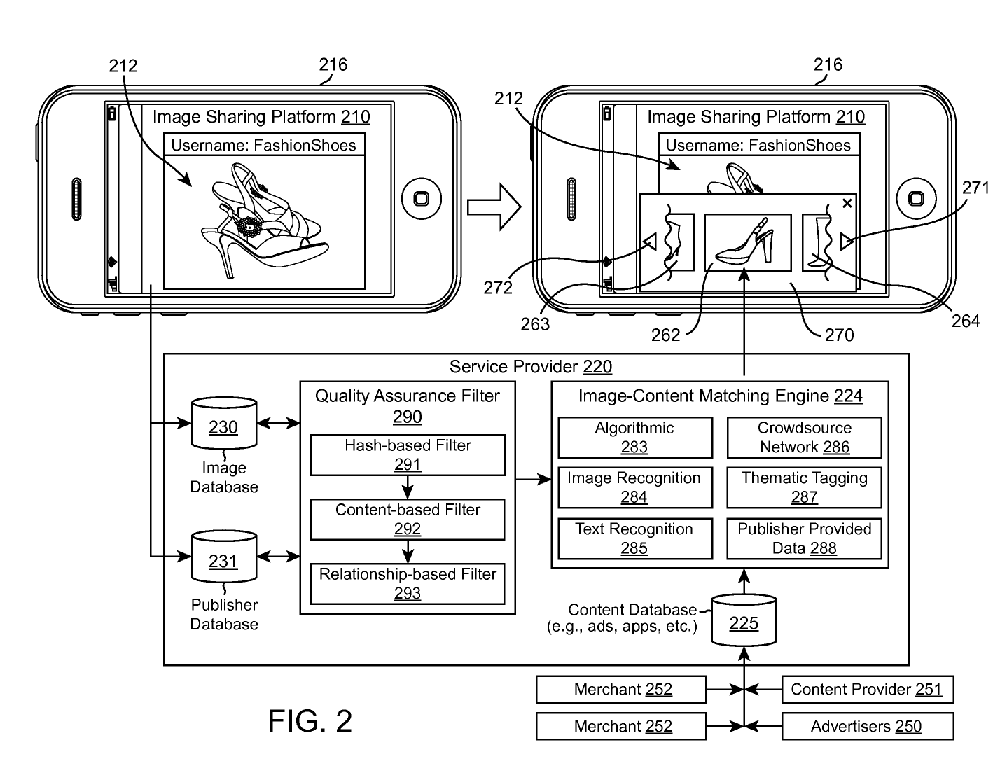

FIG. 2 is a high-level diagram illustrating another embodiment of the present invention. In the embodiment of FIG. 2, an image 212, which is published on an image sharing platform 210, and is viewable on an end-user mobile device 216, is received at an image database 230 maintained by the service provider 220. Of note, an actual copy of the image 212 need not be stored in the image database 230. For example, the image database 230 can capture and store any metadata for the image 212, a URL link of the image, any post-processing metadata associated with the image, a thumbnail of the image, an image hash of the image, or any equivalent means for identifying, viewing, or processing of the image 212. Publisher data may also be received from the image sharing platform 210, and stored in a publisher database 231.

Image and/or data collection (or “capture”) procedures include: scraping images and/or data from the image sharing platform 210; a web crawling robot; computer code for “walking the DOM tree”; a computerized “widget” to automatically queue images and/or data when the webpages are first loaded; an interface for a publisher to submit published images and/or data; and/or any combinations or equivalents thereof. The “collecting” or “capturing” of images broadly includes the identifying of, making a copy of, and/or saving a copy of the image (or associated data) into image database 230. The “collecting” or “capturing” of images may also broadly include identifying image locations (e.g., image URLs) such that the images need not be stored temporarily or permanently in image database 230, but may still be accessed when needed.

Within image database 230, images (or image identifiers) may be cataloged, categorized, sub-categorized, and/or scored based on image metadata and/or existing image tags. In one embodiment, the scoring may be based on data obtained from the image sharing platform 210. The data may be selected from the group consisting of: image hash, digital publisher identification, publisher priority, image category, image metadata, quality of digital image, size of digital image, date of publication of the digital image, time of publication of digital image, image traffic statistics, and any combination or equivalents thereof. Images may also be tagged with the location of origin of the image. Images may also be thumb-nailed, resized, or otherwise modified to optimize processing. In one embodiment, image database 230 is maintained by the service provider 220. Alternatively, the service provider 220 need not maintain, but only have access to, the image database 230.

The image 212 may then be processed through a quality assurance filter 290, before being processed through an image-content matching engine 224. As such, inappropriate images can be removed from consideration or matching with any contextually relevant content provided by advertisers 250, content provider(s) 251, and/or merchant(s) 252. When the contextually relevant content is identified, it can be delivered to the image sharing platform 210 for publication proximate to the image 212.

In the embodiment shown, the quality assurance filter 290 includes one or more sub-protocols, such as: a hash-based filter 291, a content-based filter 292, and/or a relationship-based filter 293. Within the hash-based filter 291, an image hash analysis is performed to test whether the image hash matches any known (or previously flagged) image hashes. For example, an image hash analysis can be used to automatically and quickly identify image hashes for known inappropriate (e.g., pornographic) images. Such image hash identification provides an automated and scalable means for removing inappropriate images from further analysis and processing. In another example, an image hash analysis can be used to automatically and quickly identify image hashes that have already been matched with contextually relevant content. As such, pre-matched images can bypass one or more ensuing protocols, and thereby have matching contextually relevant content sent to the image sharing platform 210 in a more expedited fashion. Image hashing algorithms are described in greater detail in Venkatesan, et al., “Robust Image Hashing,” IEEE Intn'l Conf. on Image Processing: ICIP (September 2000), which is incorporated herein by reference in its entirety.

A content-based filter 292 can then be applied to images that pass the hash-based filter 291. Within the content-based filter 292, image recognition algorithms and/or crowdsourcing protocols can be applied to review and analyze the context/content of the processed images. The content-based filter 292 may further include image pattern matching algorithms to automatically scan and detect image content based on metrics such as pattern. As such, a pattern scan of the image can be performed to compare the pattern scan of the image against a database of known images. For example, if the pattern scan of the image matches a pattern scan of a known ineligible image, then the image can be flagged as ineligible for hosting content. If the pattern scan of the image does not match a pattern scan of a known ineligible image, then the image can be submitted for further processing. The content-based filter 292 may further include text association analysis algorithms to detect metadata text and/or scrape the published page for associated text, clues, or hints of the image. As such, a comparison of the text association analysis of the image may be performed against a database of known images. For example, if the text association analysis of the image matches a known ineligible image, then the image can be flagged as ineligible for hosting content. If the text association analysis of the image does not match a known ineligible image, then the image can be submitted for further processing. In other words, a content-based filter 292 serves as a means for checking and/or verifying the context/content of the image.

A relationship-based filter 293 may be applied to images that pass both the hash-based filter 291 and/or the content-based filter 293. Within the relationship-based filter 293, publisher information (and/or other external data) can be used to determine whether the image is appropriate for hosting content. For example, there may be instances wherein the image itself is appropriate for hosting contextually relevant advertisements, but the publisher and/or platform may be deemed inappropriate. Such instances may include pornography dedicated websites and/or publishers with negative “trust scores,” ratings, or controversial reputations. Merchants, for example, may not wish to associate their advertisements with such publishers, even if a particularly published image is otherwise appropriate.

In one embodiment, to function as a means for identifying contextually relevant content for images, the image-content matching engine 224 may employ analysis system components such as: algorithmic identification 283 for analysis of the image; image recognition protocols 284; proximate text recognition 285 in search of contextual information of the image based on text published proximate to the image; submission of the image to a crowdsource network 286 to identify the context of the image and tag the image with relevant data; a thematic tagging engine 287 to identify and tag the image with relevant data, based on a pre-defined theme; publisher provided information database 288; and/or any combinations or equivalents thereof. Aspects of the system components of the image-content matching engine 224 are described in the above identified related applications, which have been incorporated by reference herein.

For example, within the algorithmic identification system component 283, an analysis may be performed to identify data, tags, or other attributes of the image. Such attributes may then be used to identify and select contextually relevant content that matches the same attributes. For example, an algorithm may be provided that identifies contextually relevant content having the same subject tag and size of the published image. Such contextually relevant content is then provided back to the end-user device for display in spatial relationship with the originally published image. The algorithmic identification system component 283 may also include a positional analysis to tag/link contextually relevant content to specific locations on the original image. As such, contextually relevant content can be not only specific to the image as a whole, but also specific to a position indicative of specific content within the image.

Image recognition system component 284 may employ one or more image recognition protocols in order to identify the subject matter of (or within) the image. An output of the image recognition system component 284 may then be used to identify and select contextually relevant content to be provided back to the end-user device. Image recognition algorithms and analysis programs are publicly available; see, for example, Wang et al., “Content-based image indexing and searching using Daubechies' wavelts,” Int J Digit Libr (1997) 1:311-328, which is herein incorporated by reference in its entirety.

Text recognition system component 285 may collect and analyze text that is published proximate to the image. Such text may provide contextual clues as to the subject matter of (or within) the image. Such contextual clues may then be used to identify and select contextually relevant content to be provided back to the end-user device. Examples of text recognition system components are described in U.S. Patent Application Publication No. 2012/0177297, which has been incorporated herein by reference.

A crowdsource network 286, alone or in combination with the additionally mentioned system components, may also be provided to identify and select contextually relevant content. In one embodiment, for example, a crowdsource network 286 is provided with an interface for receiving, viewing, and/or tagging images published on one or more digital content platforms. The crowdsource network 286 can be used to identify the context of the image and/or identify and select contextually relevant content that is associated with the image. The crowdsource network 286 may be provided with specific instructions on how to best match images with associated content. The crowdsource network 286 may also perform a positional analysis to tag/link contextually relevant content to specific locations on the original image. As such, contextually relevant content can be not only specific to the image as a whole, but also specific to a position indicative of specific content within the image.

A thematic tagging engine 287, alone or in combination with the additionally mentioned system components, may also be provided to identify and select contextually relevant content. In one embodiment, for example, the thematic tagging engine 287 works in conjunction with the crowdsource network 286 to receive, view, and/or tag images published on one or more digital content platforms based on specific themes. Themes may include marketable considerations provided by one or more third-party merchants wishing to use the published images as an advertising mechanism. Examples of thematic tagging systems are described in more detail in U.S. patent application Ser. No. 13/299,280, which has been incorporated herein by reference.

The image-content matching engine 224 may also be directly linked to the publication platform to collect publisher provided information 288 with respect to the published image. For example, the publisher may provide criteria for selecting which images are subject to analysis. The publisher may also be provided with a “dashboard” or interface to configure various settings for the service provider's analysis. For example, the publisher can select what categories of contextually relevant content (e.g., in the form of informational categories, interactive functions, etc.) to be provided with respect to the published images. In one example, the publisher may select interactive applications as described in U.S. patent application Ser. No. 13/308,401, which has been incorporated herein by reference. The publisher may also select what third-party merchants may be used to provide advertisements for any particular image (or subset of images).

In operation, software embedded in the image sharing platform 210 may monitor the end-user's interactions with the image 212. If the end-user activates the image 212 (by, for example, clicking on a hotspot, viewing the image for a defined period of time, swiping the image with their finger, etc.), the image sharing platform 210 sends a call to the service provider 220 to request contextually relevant content for the image 212. The image sharing platform 210 receives the contextually relevant content from the service provider 220, and then displays the contextually relevant content proximate to the originally published image 212. In one embodiment, the image sharing platform 210 displays the contextually relevant content within the same pixel profile (i.e., the same pixel space) of the originally published image 212. As such, the contextually relevant content can be displayed without affecting any of the other content published on the image sharing platform 212. For example, the image sharing platform 210 can display the contextually relevant content on the apparent backside of the image, as a replacement image within the image frame, or (as shown in FIG. 2) within and image frame 270 overlaying the originally published image 212. Further, by providing the contextually relevant content within a spatial relationship with respect to the image 212, the end-user is more focused on the contextually relevant content, without ruining the original aesthetic design provided by the image sharing platform 210.

In FIG. 2, the image frame 270 may include one or more hotspots 271, 272 (i.e., icons, buttons, activation interfaces, etc.), to allow the end-user to scroll through multiple pieces of contextually relevant content 262, 263, and 264. In certain embodiments, the different pieces of contextually relevant content 262, 263, and 264 may be images, ads, videos, text, etc., which are contextually relevant to each other, to the image 212, and/or to the other content on the image sharing platform 210. For example, the content 262, 263, and 264 may provide contextually relevant advertisements serving as hyperlinks to a merchant or third-party website. As would be understood by one of skill in the art, any user-actionable interface (including detectable touchscreen swiping motions) may be provided (or otherwise programmed) to allow a user to browser between content 262, 263, and 264 within image frame 270.

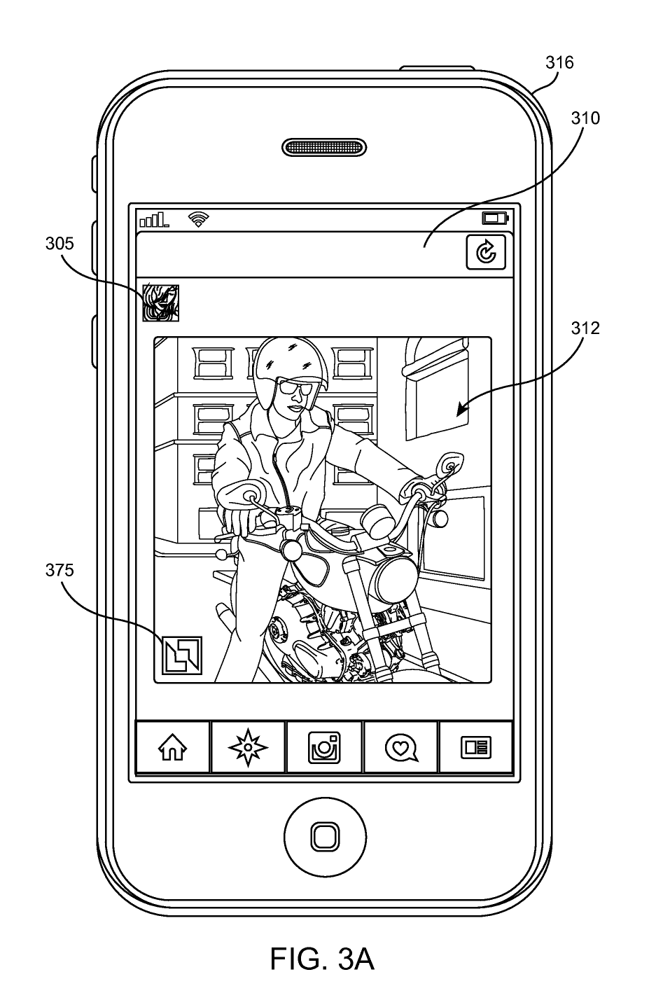

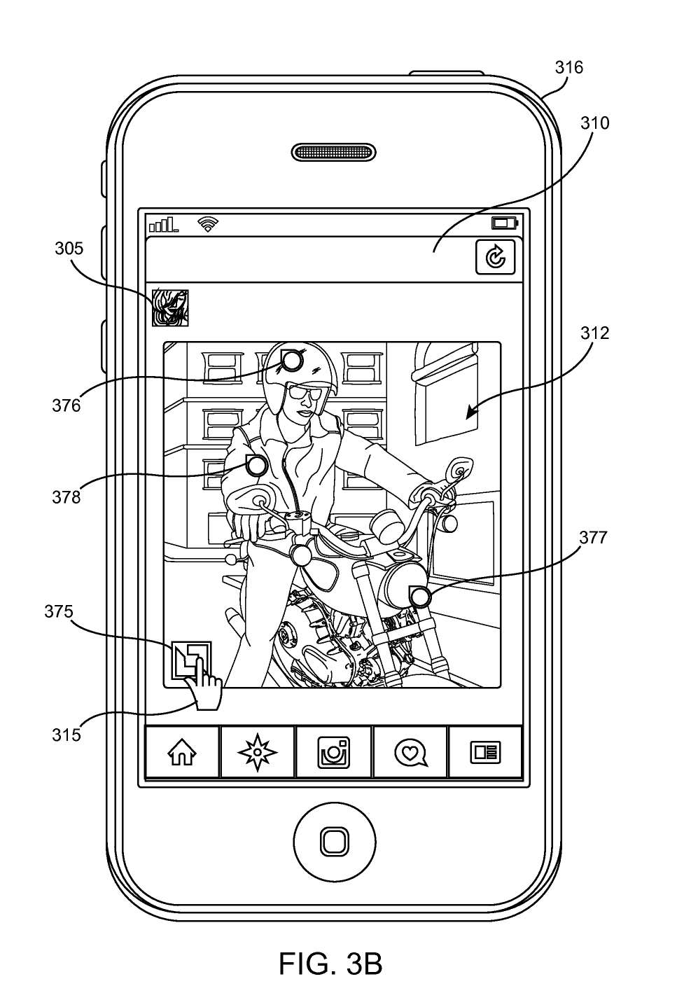

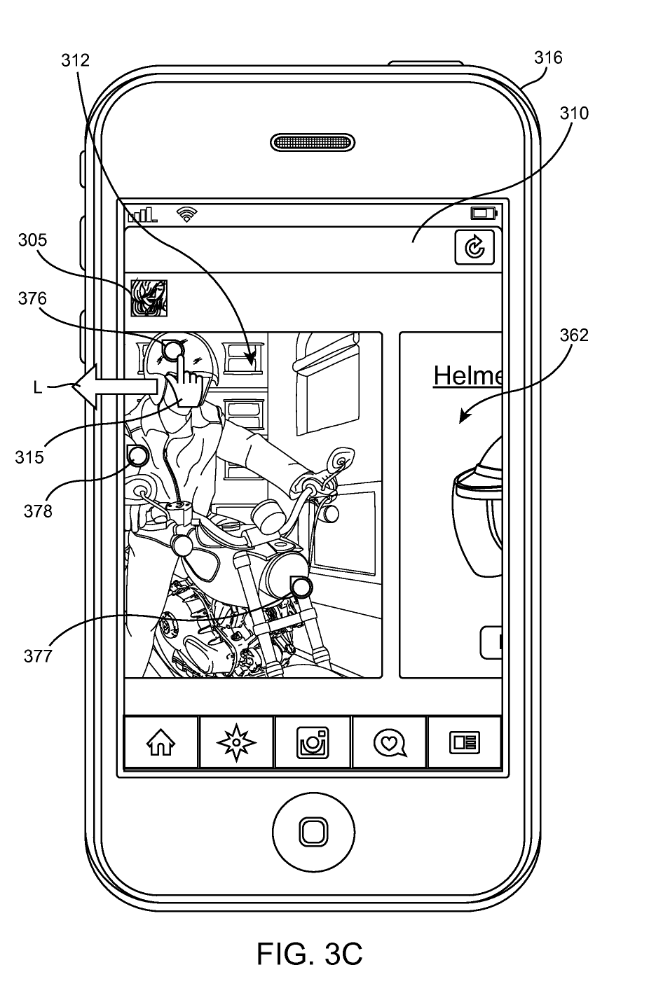

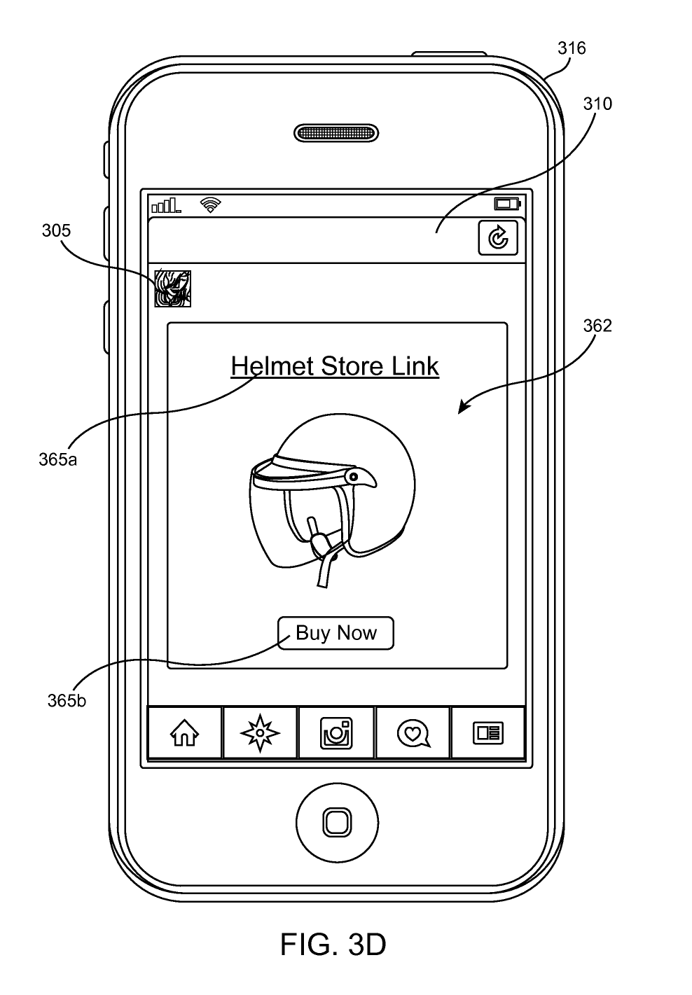

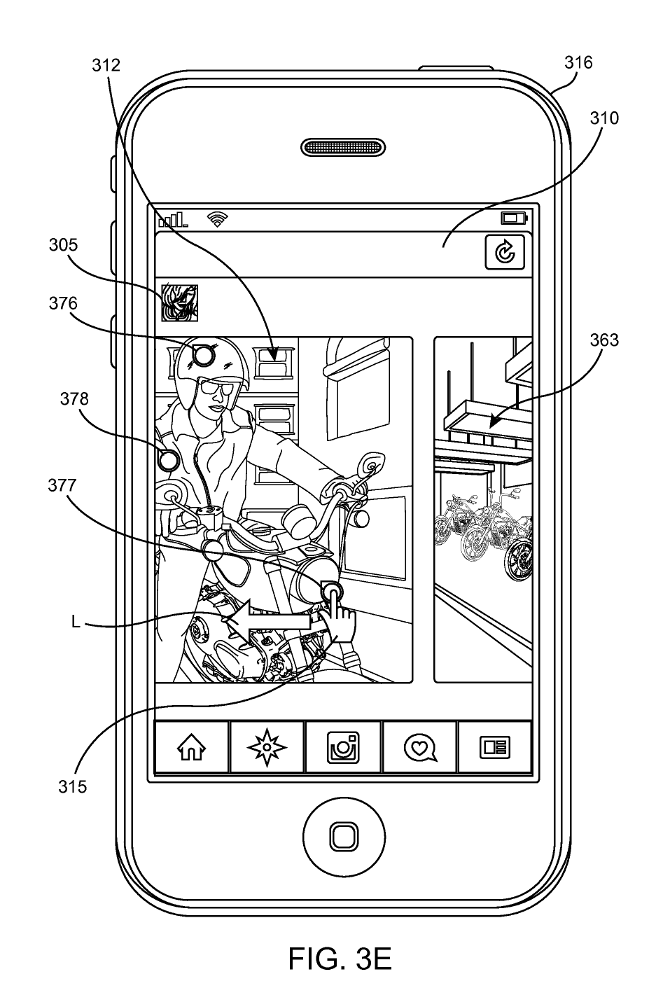

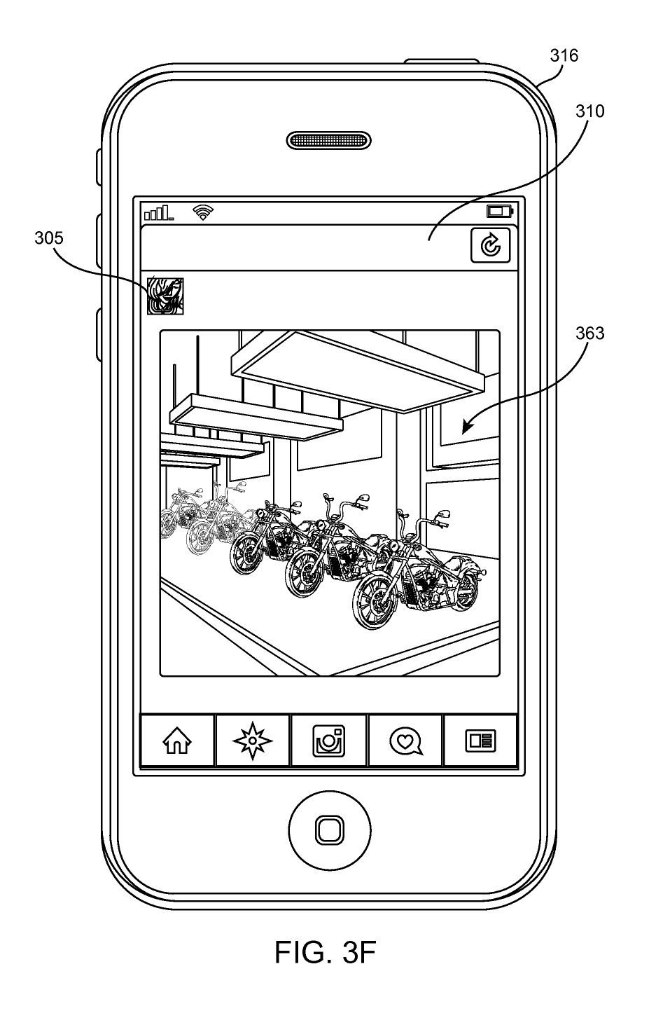

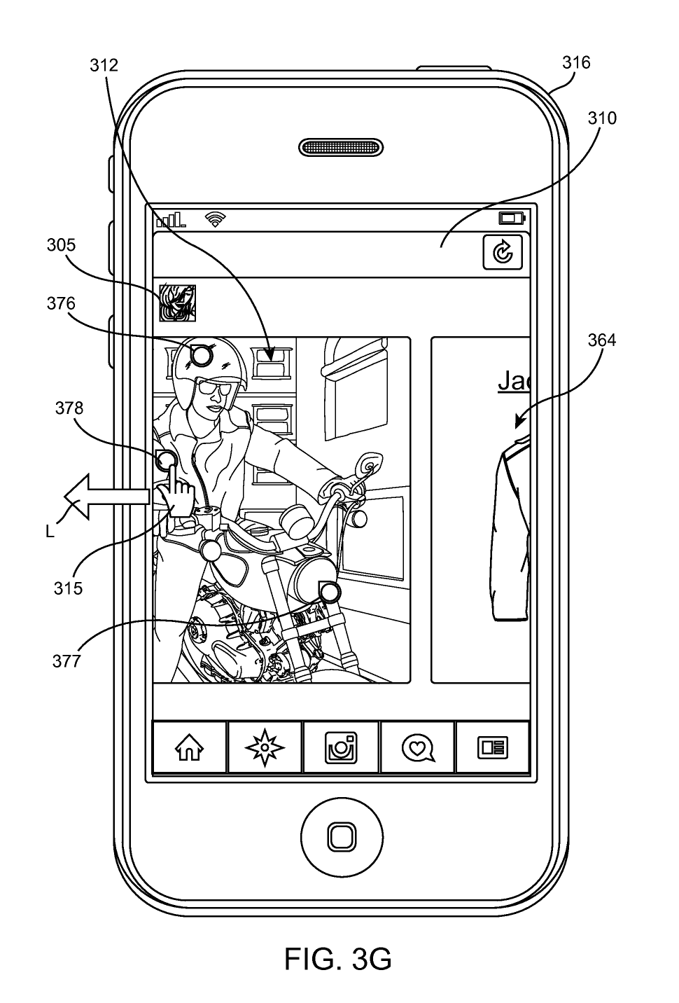

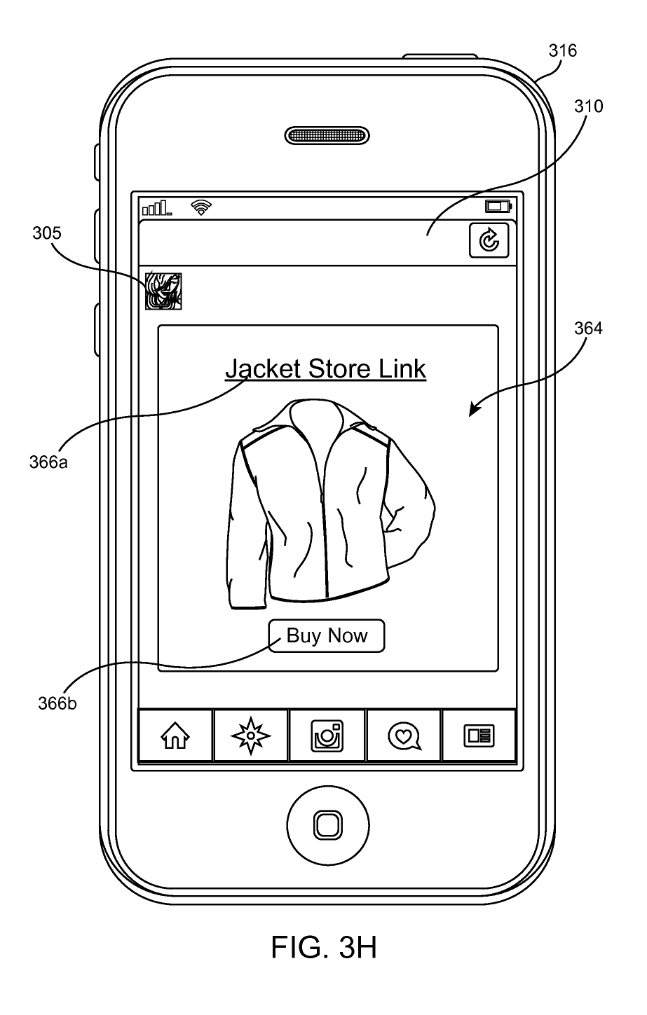

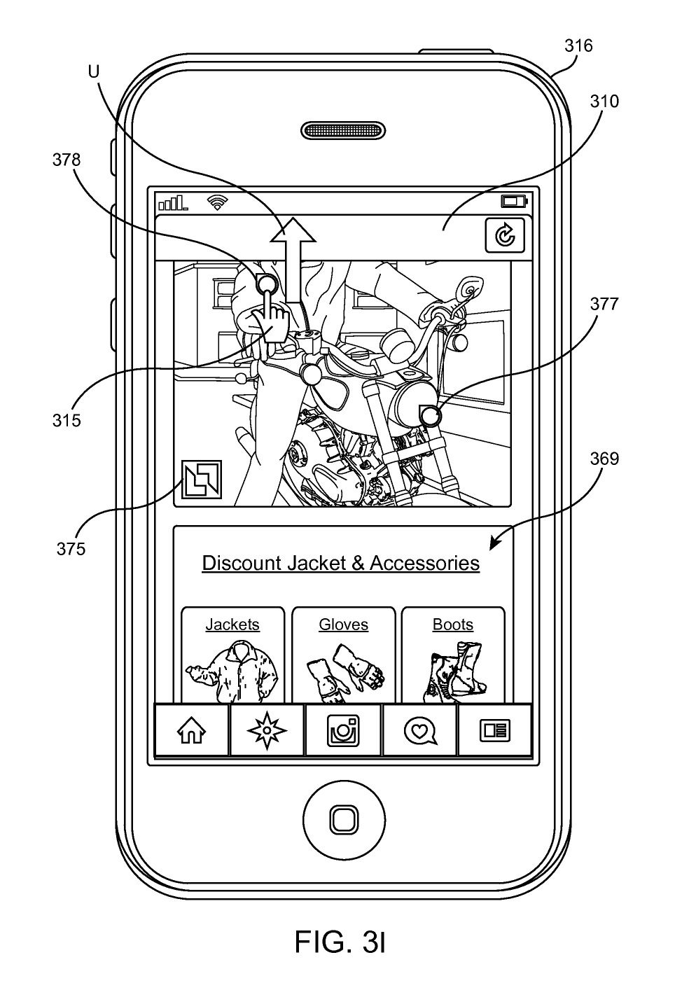

FIGS. 3A-3I are screenshots showing an example implementation of the disclosed systems and methods. In FIG. 3A, an image 312 is published on a digital content platform 310, such as an image sharing platform, on a mobile device 316. In the example shown in FIG. 3A, the image 312 is user-generated content, provided by a first user, such as a publisher 305. A hotspot 375 (or icon, button, etc.) may be provided to allow a second user (i.e., end-user) to activate the image 312, thus allowing the end-user to express interest in the content within the image. In practice, and as shown in FIG. 3B, when an end-user 315 actuates the hotspot 375, one or more positionally matched hotspots 376, 377, and 378 may be provided on the image 312. The positionally matched hotspots 376, 377, and 378 may be matched to content within the image 312, in order to suggest the availability of additional content relative to the subject matter proximate to the hotspot. The positional matching information for the content within the image may be received from a service provider, as described above.

As shown in FIG. 3C, when the end-user 315 selects a specific hotspot 376, and activates the hotspot by, for example, swiping the hotspot in a direction “L,” contextually relevant content 362, which is received from the service provider, is displayed for the end-user (FIG. 3D). Preferably, the content 362 is contextually relevant to the content that is positionally matched with the end-user selected hotspot 376. For example, hotspot 376 is positionally matched to the helmet worn by the motorcycle rider. As such, when the end-user 315 swipes the hotspot 376, the end-user 315 has indicated that they are interested in the helmet. As such, content 362 can serve as an advertisement for helmets, with links 365a and 365b where the end-user can be directed to purchase a similar helmet.

Alternatively, if the end-user 315 selects and swipes the hotspot 377, which is positionally matched to the motorcycle, contextually relevant content 363 may be displayed to the end-user, as shown in FIGS. 3E and 3F. On the other hand, if the end-user 315 selects and swipes the hotspot 378, which is positionally matched to the jacket, contextually relevant content 364 may be displayed to the end-user, as shown in FIGS. 3G and 3H. As such, the end-user's selection of the positionally matched hotspot provides the end-user access to content that is relevant to what they have selected. Additionally, a directional component may be implemented such that if the end-user 315 swipes a positionally matched hotspot (e.g., 378) in a different direction (e.g., direction “U”), different contextually relevant content 369 is displayed to the end-user.

### Additional Embodiments

In another embodiment, there is provided computer-implement systems and methods for displaying advertisements and/or any contextually relevant content associated with images published on a digital content platform, such as a mobile device software application. The systems and methods comprise: (a) publishing an image on the mobile device software application; (b) identifying when an end-user has activated the image; (c) providing one or more hotspots on the image, wherein each hotspot is positionally matched to content within the image, and wherein each hotspot is linked to an advertisement or contextually relevant content, which is selected based in part on the positionally matched content within the image; and (d) upon an end-user's swiping of an end-user selected hotspot, displaying the advertisement or contextually relevant content linked to the end-user selected hotspot. The advertisement or contextually relevant content may cover the entirety of the image. The systems and methods may further comprise: (e) submitting the image to a service provider, wherein the service provider performs the steps of (1) analyzing the content within the image, (2) creating positional tags for content within the image, (3) identifying at least one advertisement or contextually relevant content for the content within the image, and (4) linking the identified advertisement or contextually relevant content to the positional tags. The systems and methods may further comprise: (f) receiving the advertisement or contextually relevant content and positional tags from the service provider; and (g) using the positional tags to match content within the image to respective hotspots. The end-user may activate the image via a touchscreen interface on a mobile device. The end-user's swiping of the end-user selected hotspot may be performed via a touchscreen interface on the mobile device. The systems and methods may further comprise: (h) upon the end-user's swiping of the advertisement or contextually relevant content, displaying a second advertisement over the image; and/or (i) upon the end-user's swiping of the advertisement or contextually relevant content, displaying a second contextually relevant content over the image. The first or second advertisement, and/or the first or second contextually relevant content may be selected based on a direction of the end-user's swiping.

The systems and methods may further comprise submitting the image to an image-content matching engine to match content within the image to associated advertisements or contextually relevant content. The image-content matching engine may include a crowdsourcing network interface and/or a proximate text recognition engine to match content within the image to associated advertisements or contextually relevant content based on text published proximate to the image.

In another embodiment, there is provided systems and methods for displaying advertisements or other third party content over an image published on a digital content platform. The systems and methods comprise: (a) submitting an image to an image-content matching engine, wherein the image-content matching engine (1) analyzes content within the image to identify at least one advertisement or other third party content contextually relevant to the content within the image, and (2) positionally tags the content within the image to the identified advertisement or other third party content. The systems and methods may further comprise: (b) publishing the image on the digital content platform; (c) providing one or more hotspots on the image, wherein each hotspot is positionally matched to content within the image; (d) identifying when an end-user swipes a hotspot; and (e) displaying the advertisement or other third party content linked to the end-user selected hotspot over the image. The advertisement or other third party content can cover the entirety of the image. The digital content platform may be a software application on a mobile device. The image-content matching engine may include a crowdsourcing network interface. The image-content matching engine may include a proximate text recognition engine to match content within the image to associated advertisements based on text published proximate to the image on the digital content platform. The systems and methods may further comprise: (f) upon the end-user's swiping of the advertisement, displaying a second advertisement over the image; and/or (g) upon the end-user's swiping of the advertisement, displaying a second contextually relevant content over the image. The second contextually relevant content is selected based on a direction of the end-user's swiping.

In one embodiment, there is provided a method for displaying contextually relevant content that includes providing a publisher with a reference script for publication with an image on a digital content platform. A data set may be received from the publisher. The data set may include inputs such as: image identification data, referrer data, image constants (or metadata, or annotations), publisher hint strings, and/or any other general site specific data. The data set may be submitted to an image analysis engine. The image analysis engine may include: an algorithmic matching engine, a proximate text recognition engine, a crowdsourcing network, and/or a thematic tagging engine. Contextually relevant content is then identified based on the context of the image. The contextually relevant content may be in many forms; for example, a contextually relevant ad creative, text, videos, images, third-party applications, etc. The contextually relevant content is the provided to the end user's device for publication proximate to the originally published image.

I still another embodiment, there is provided a method for displaying advertisements or other contextually relevant content associated with images published in a mobile device software application. The method comprises: (a) publishing an image on the mobile device software application; (b) identifying when an end-user has activated the image, wherein the end-user activates the image via a touchscreen interface on the mobile device; and (c) submitting the image to an image-content matching engine, wherein the image-content matching engine includes a crowdsourcing network interface, and wherein the image-content matching engine performs the steps of 1) analyzing the content within the image, 2) creating positional tags for content within the image, 3) identifying at least one advertisement or other contextually relevant content for the content within the image, and 4) linking the identified advertisement or other contextually relevant content to the positional tags. The method further comprises: (d) receiving the advertisement or other contextually relevant content and the positional tags from the image-content matching engine; (e) providing one or more hotspots on the image, wherein each hotspot is positioned proximate to content within the image based on the respective positional tag, and wherein each hotspot is linked to the received advertisement or other contextually relevant content; and (f) upon an end-user's swiping of an end-user selected hotspot, displaying the advertisement or other contextually relevant content linked to the end-user selected hotspot, wherein the end-user's swiping of the end-user selected hotspot is performed via a touchscreen interface on the mobile device.

### Communication Between Components/Parties Practicing the Present Invention.

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto.

### Computer Implementation.

In one embodiment, the invention is directed toward one or more computer systems capable of carrying out the functionality described herein. The patents and applications incorporated by reference above include one or more schematic drawings of a computer system capable of implement the methods presented above.

Computer systems for carrying out the presented methods may include one or more processors connected to a communication infrastructure (e.g., a communications bus, cross-over bar, or network). Computer systems may include a main memory, such as random access memory (RAM), and may also include a secondary memory, such as a hard disk drive, a removable storage drive, an optical disk drive, a flash memory device, a solid state drive, etc.

In this document, the terms “computer-readable storage medium,” “computer program medium,” and “computer usable medium” are used to generally refer to any non-transient computer readable media such as a removable storage drive, removable storage units, a hard disk installed in hard disk drive, and any other computer-readable media exclusive of transient signals. These computer program products provide computer software, instructions, and/or data to the computer system. These computer program products also serve to transform a general purpose computer into a special purpose computer programmed to perform particular functions, pursuant to instructions from the computer program products/software. Embodiments of the present invention are directed to such computer program products.

In an embodiment where the invention is implemented using software, the software may be stored in a computer program product and loaded into a computer system using a removable storage drive, an interface, a hard drive, a communications interface, or equivalents thereof. The control logic (software), when executed by a processor, causes the processor to perform the functions and methods described herein. Where appropriate, a processor, and/or associated components, and equivalent systems and sub-systems serve as “means for” performing selected operations and functions. Such “means for” performing selected operations and functions also serve to transform a general purpose computer into a special purpose computer programmed to perform said selected operations and functions.

Embodiments of the invention, including any systems and methods described herein, may also be implemented as instructions stored on any machine-readable medium, which may be read and executed by one or more machine components. A machine-readable medium may include any mechanism for storing or transmitting information in a form readable by a machine. For example, a machine-readable medium may include read only memory (ROM); random access memory (RAM); magnetic disk storage media; optical storage media; flash memory devices; solid state memory devices; or equivalents thereof. Further, firmware, software, routines, instructions may be described herein as performing certain actions.

In one embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

In one embodiment, there is provided a computer-readable storage medium for providing a contextually relevant advertisements proximate to an image published on a digital content platform. The computer-readable storage medium includes instructions executable by at least one processing device that, when executed, cause the processing device to: (a) provide a publisher with a reference script for publication with an image on a digital content platform, wherein the reference script is a computer-readable instruction that causes an end-user device to send data to a service provider processing unit, and wherein the data includes image identification data; (b) receive the data from a publisher; (c) submit the data to an image-content matching engine, wherein the image identification data is used to match a contextually relevant advertisement to the image; and (d) provide the contextually relevant advertisement to the end-user device for publication proximate to the image on the digital content platform.

In another embodiment, there is provided a computer-readable storage medium for displaying advertisements associated with images published in a mobile device software application. The computer-readable storage medium comprises instructions executable by at least one processing device, which when executed, cause the processing device to: (a) publish an image on the mobile device software application, (b) identify when an end-user has activated the image, (c) provide one or more hotspots on the image, wherein each hotspot is positionally matched to content within the image, and wherein each hotspot is linked to an advertisement selected based in part on the positionally matched content within the image, and (d) upon an end-user's swiping of an end-user selected hotspot, display the advertisement linked to the end-user selected hotspot over the image. The advertisement may cover the entirety of the image.

The computer readable medium may further comprise instructions executable by at least one processing device, which when executed, cause the processing device to: (e) submit the image to a service provider, wherein the service provider performs the steps of (1) analyzing the content within the image, (2) creating positional tags for content within the image, (3) identifying at least one advertisement for the content within the image, and (4) linking the identified advertisement to the respective positional tag. The computer-readable storage medium may further comprise instructions to: (f) receive the advertisement and positional tags from the service provider, and (g) use the positional tags to match content within the image to respective hotspots. The end-user may activate the image via a touchscreen interface on the mobile device. For example, the end-user's swiping of the end-user selected hotspot may be performed via a touchscreen interface on the mobile device.

The computer readable medium may further comprise instructions executable by at least one processing device, which when executed, cause the processing device to: (h) submit the image to an image-content matching engine to match content within the image to associated advertisements, (i) display a second advertisement over the image when the end-user's swipes the advertisement, and/or (j) display a second contextually relevant content over the image when the end-user swipes the advertisement. The image-content matching engine may include a crowdsourcing network interface and/or a proximate text recognition engine to match content within the image to associated advertisements based on text published proximate to the image in the mobile device software application. The second contextually relevant content may be selected based on a direction of the end-user's swiping.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Accordingly, it is to be understood that this invention is not limited to particular embodiments described, and as such may vary. It is also to be understood that the terminology used herein is for the purpose of describing particular embodiments only, and is not intended to be limiting.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Further, each system component and/or method step presented should be considered a “means for” or “step for” performing the function described for said system component and/or method step. As such, any claim language directed to a “means for” or “step for” performing a recited function refers to the system component and/or method step in the specification that performs the recited function, as well as equivalents thereof.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A method for displaying advertisements or other contextually relevant content associated with images published in a mobile device software application, the method comprising:
publishing an image on the mobile device software application;
identifying when an end-user has activated the image, wherein the end-user activates the image via a touchscreen interface on the mobile device;
submitting the image to an image-content matching engine, wherein the image-content matching engine includes a crowdsourcing network interface, and wherein the image-content matching engine performs the steps of 1) analyzing the content within the image, 2) creating positional tags for locations of content within the image, 3) identifying at least one advertisement or other contextually relevant content for the content within the image, and 4) linking the identified advertisement or other contextually relevant content to the positional tags;
receiving the advertisement or other contextually relevant content and the positional tags from the image-content matching engine;
providing one or more hotspots on the image, wherein each hotspot is positioned proximate to content within the image based on the location of the respective positional tag, and wherein each hotspot is linked to the received advertisement or other contextually relevant content; and
upon an end-user's swiping of an end-user selected hotspot, displaying the advertisement or other contextually relevant content linked to the end-user selected hotspot, wherein the end-user's swiping of the end-user selected hotspot is performed via a touchscreen interface on the mobile device.

2. A method for displaying advertisements associated with images published in a mobile device software application, the method comprising:
publishing an image on the mobile device software application;
identifying when an end-user has activated the image;
providing one or more hotspots on the image, wherein each hotspot is positionally matched to a location of content within the image, and wherein each hotspot is linked to an advertisement selected based in part on the positionally matched content within the image; and
upon an end-user's swiping of an end-user selected hotspot, displaying the advertisement linked to the end-user selected hotspot.

3. The method of claim 2, further comprising:
submitting the image to a service provider, wherein the service provider performs the steps of 1) analyzing the content within the image, 2) creating positional tags for locations of content within the image, 3) identifying at least one advertisement for the content within the image, and 4) linking the identified advertisement to the positional tags;
receiving the advertisement and the positional tags from the service provider; and
using the positional tags to match locations of the content within the image to respective hotspots.

4. The method of claim 2, wherein the end-user activates the image via a touchscreen interface on the mobile device.

5. The method of claim 2, wherein the end-user's swiping of the end-user selected hotspot is performed via a touchscreen interface on the mobile device.

6. The method of claim 2, further comprising:
submitting the image to an image-content matching engine to match content within the image to associated advertisements.

7. The method of claim 6, wherein the image-content matching engine includes a crowdsourcing network interface.

8. The method of claim 6, wherein the image-content matching engine includes a proximate text recognition engine to match content within the image to associated advertisements based on text published proximate to the image in the mobile device software application.

9. The method of claim 2, wherein the advertisement covers the entirety of the image.

10. The method of claim 2, further comprising:
upon the end-user's swiping of the advertisement, displaying a second advertisement over the image.

11. The method of claim 2, further comprising:
upon the end-user's swiping of the advertisement, displaying a second contextually relevant content over the image.

12. The method of claim 11, wherein the second contextually relevant content is selected based on a direction of the end-user's swiping.

13. A non-transient computer readable medium for displaying advertisements associated with images published in a mobile device software application, comprising:
instructions executable by at least one processing device, which when executed, cause the processing device to
publish an image on the mobile device software application,
identify when an end-user has activated the image,
provide one or more hotspots on the image, wherein each hotspot is positionally matched to a location of content within the image, and wherein each hotspot is linked to an advertisement selected based in part on the positionally matched content within the image, and
upon an end-user's swiping of an end-user selected hotspot, display the advertisement linked to the end-user selected hotspot over the image.

14. The computer readable medium of claim 13, further comprising:
instructions executable by at least one processing device, which when executed, cause the processing device to
submit the image to a service provider, wherein the service provider performs the steps of (1) analyzing the content within the image, (2) creating positional tags for locations of content within the image, (3) identifying at least one advertisement for the content within the image, and (4) linking the identified advertisement to the respective positional tag,
receive the advertisement and the positional tags from the service provider, and
use the positional tags to match locations of the content within the image to respective hotspots.

15. The computer readable medium of claim 13, wherein the end-user activates the image via a touchscreen interface on the mobile device.

16. The computer readable medium of claim 13, wherein the end-user's swiping of the end-user selected hotspot is performed via a touchscreen interface on the mobile device.

17. The computer readable medium of claim 13, further comprising:
instructions executable by at least one processing device, which when executed, cause the processing device to submit the image to an image-content matching engine to match content within the image to associated advertisements.

18. The computer readable medium of claim 13, wherein the image-content matching engine includes a crowdsourcing network interface.

19. The computer readable medium of claim 13, wherein the image-content matching engine includes a proximate text recognition engine to match content within the image to associated advertisements based on text published proximate to the image in the mobile device software application.

20. The computer readable medium of claim 13, wherein the advertisement covers the entirety of the image.

21. The computer readable medium of claim 13, further comprising:
instructions executable by at least one processing device, which when executed, cause the processing device to display a second advertisement over the image when the end-user's swipes the advertisement.

22. The computer readable medium of claim 12, further comprising:
instructions executable by at least one processing device, which when executed, cause the processing device to display a second contextually relevant content over the image when the end-user swipes the advertisement.

23. The computer readable medium of claim 22, wherein the second contextually relevant content is selected based on a direction of the end-user's swiping.

24. A method for displaying advertisements or other third party content over an image published on a digital content platform, the method comprising:
submitting an image to an image-content matching engine, wherein the image-content matching engine (1) analyzes content within the image to identify at least one advertisement or other third party content contextually relevant to the content within the image, and (2) positionally tags locations of the content within the image to the identified advertisement or other third party content;
publishing the image on the digital content platform;
providing one or more hotspots on the image, wherein each hotspot is positionally matched to a location of content within the image;
identifying when an end-user swipes a hotspot; and
displaying the advertisement or other third party content linked to the end-user selected hotspot over the image.

25. The method of claim 24, wherein the digital content platform is a software application on a mobile device.

26. The method of claim 24, wherein the image-content matching engine includes a crowdsourcing network interface.

27. The method of claim 24, wherein the image-content matching engine includes a proximate text recognition engine to match content within the image to associated advertisements based on text published proximate to the image on the digital content platform.

28. The method of claim 24, wherein the advertisement or other third party content covers the entirety of the image.

29. The method of claim 24, further comprising:
upon the end-user's swiping of the advertisement or other third party content, displaying a second advertisement or other third party content over the image.

30. The method of claim 29, wherein the second advertisement or other third party content is selected based on a direction of the end-user's swiping.
